(19) United States
(12) Patent Application Publication
(10) Pub. No.: US 2025/0021845 A1
(43) Pub. Date: Jan. 16, 2025

(54) METHOD AND A SYSTEM FOR PERFORMING A REAL-TIME PREDICTIVE MODELING OF AN ARTIFICIAL NEURAL NETWORK MODEL AT A CLIENT DEVICE

(71) Applicant: Affle MEA FZ-LLC, Dubai (AE)

(72) Inventors: Charles Yong, Bnei-Brak (IL); Eran Kariti, Bnei-Brak (IL); Idan Fonea, Bnei-Brak (IL)

(73) Assignee: Affle MEA FZ-LLC, Dubai (AE)

(21) Appl. No.: 18/897,543

(22) Filed: Sep. 26, 2024

Related U.S. Application Data
(63) Continuation-in-part of application No. 18/450,874, filed on Aug. 16, 2023, now abandoned.
Application No. 18/450,874 is a continuation of application No. 16/487,855, filed on Aug. 22, 2019, now abandoned.
(60) Provisional application No. 62/461,812, filed on Feb. 22, 2017.

(51) Int. Cl. G06N 5/046; G06N 20/00; G06Q 30/0241

(52) U.S. Cl. CPC G06N 5/046; G06Q 30/0241; G06N 20/00

(57) ABSTRACT

According to an aspect of one or more embodiments, a system for performing a real-time predictive modeling at a client device may include an ANN model in the client device configured to generate an inference performance associated with the trainable ANN model associated with an action performed at the client device based on data comprising a plurality of features associated with the client device, wherein the inference performance is transmitted. The trainable ANN model is configured to receive a loss calculation generated based on the inference performance, indicating a requirement to correct the trainable ANN model, wherein the trainable ANN model generates one or more corrections for coefficients of the trainable ANN model based on the loss calculation. The trainable ANN model is configured to generate one or more coefficients associated with the trainable ANN model and the data, by convoluting the data, and the trainable model. The trainable ANN model is configured to transmit one or more of the one or more corrections and the one or more coefficients indicating a successful predictive modeling of the trainable ANN model with the generation of the trainable ANN model.

### CROSS REFERENCE TO OTHER APPLICATION

This application is a continuation-in-part with respect to U.S. patent application Ser. No. 18/450,874 filed on Aug. 16, 2023.

### FIELD

The present invention relates generally to generating predictive models. More specifically, the present invention relates to generating predictive models of mobile users' behavior, through real-time data collection and analysis.

### BACKGROUND

Mobile advertising has become a cornerstone of digital marketing, leveraging user data to deliver personalized and targeted advertisements. Traditionally, user data is collected and processed on centralized servers to build user profiles and make advertising decisions. However, this approach raises significant privacy concerns and compliance challenges, especially with stringent regulations like the General Data Protection Regulation (GDPR), which restrict the handling and transfer of personal data. Obviously, remote servers modeling perform significantly lower without access to quality data that is able to detect more complex patterns. This increases the mismatch between an offer to a user and causes a significant waste. The core challenge was to develop a system that balances the need for accurate user profiling and ad targeting with stringent GDPR compliance. Traditional server-side processing of personal data is not feasible under GDPR, which mandates that personal data should not be sent to external servers without explicit user consent and adequate protections.

The subject matter claimed in this disclosure is not limited to embodiments that solve any disadvantages or that operate only in environments such as those described above. Rather, this background is only provided to illustrate one example technology area where some embodiments described in this disclosure may be practiced.

### SUMMARY

Embodiments of the present invention disclose a method for performing a real-time predictive modeling of a trainable Artificial Neural Network (ANN) model at a client device. According to some embodiments, the method includes the steps of: generating, by the trainable ANN model deployed at a client device, an inference performance associated with an action performed at the client device based on data comprising a plurality of features associated with the client device, wherein the inference performance is transmitted; receiving, by the trainable ANN model, a loss calculation generated based on the inference performance associated with the trainable ANN model, indicating a requirement to correct the trainable ANN model, wherein the trainable ANN model generates one or more corrections for coefficients of the trainable ANN model based on the loss calculation; generating, by the trainable ANN model, one or more coefficients associated with the trainable ANN model and the data, by convoluting the data, and the trainable ANN model; and transmitting, by the trainable ANN model, one or more of the one or more corrections and the one or more coefficients indicating a successful predictive modeling of the trainable ANN model with the generation of the trainable ANN model.

According to some embodiments, the inference performance and one or more of the one or more corrections and the one or more coefficients is transmitted to a remote server.

According to some embodiments, the remote server generates the loss calculation based on the inference performance and updates a global model based on the one or more coefficients and the one or more corrections.

According to some embodiments, a remote server generates the loss calculation based on the inference performance and updates a global model based on the one or more coefficients and the one or more corrections.

According to some embodiments, the client device generates the loss calculation based on the inference performance.

According to some embodiments, the method further includes collecting, by a Software Development Kit (SDK), data associated with the client device as a feature vector from the client device; creating, by the SDK, a user profile for the user based on the data; deploying, by the SDK, the trainable ANN model at the client device, wherein the trainable ANN model is generated based on global data at a remote server; and processing, by the trainable ANN model, the data comprising a plurality of features associated with the client device to generate an output corresponding to performing an action at the client device.

According to some embodiments, the method further includes selecting a first coefficient amongst the one or more coefficients associated with a higher layer of the trainable ANN model. The higher layer corresponds to an output based on the data; generating an encryption layer of a plurality of pseudo random numbers based on the first coefficient; adding a noise to the encryption layer and the first coefficient; and transmitting the first coefficient to a remote server.

According to some embodiments, the method further includes generating at least one correction amongst the one or more corrections incorporated to a previous coefficient of the trainable ANN model; and transmitting the at least one correction, wherein the at least one correction corresponds to a masked image of an activating pattern associated with the trainable ANN model.

According to some embodiments, the method further includes dividing the trainable ANN model based on personal features and open source features amongst the data, into a personal data model and a public data model; and transmitting at least one coefficient associated with the public data model associated with the open source features to the remote server.

According to some embodiments, the method further includes receiving, by a remote server, the one or more coefficients from the client device; aggregating, by the remote server, one or more weight updates with respect to the trainable ANN model; and generating, by the remote server, an updated global model with a time stamp and a version tag based on the one or more weight updates.

According to some embodiments, the output comprises one or more advertisements, one or more model based offers and the action to be performed is displaying one of the one or more advertisements and the one or more model based offers at the client device.

According to some embodiments, the one or more advertisements, and the one or more model based offers is selected amongst a plurality of advertisements and a plurality of model based offers stored in the client device along with the trainable ANN model.

According to some embodiments, one or more advertisements and one or more model based offers is selected amongst a plurality of advertisements and a plurality of model based offers stored in the client device along with the trainable ANN model.

According to some embodiments, the method further includes generating, by the trainable ANN model, a prediction score and a snapshot of the plurality of features in the data used to generate the output; and compressing, by the trainable ANN model, the prediction score and the snapshot, wherein the prediction score and the snapshot is stored at the client device.

According to some embodiments, the inference performance is generated based on a response received from a user to the action performed at the client device.

According to some embodiments, the plurality of features comprises a Wi-Fi connection status, demographic information, one or more device specifics, application usage data, a geolocation, and or more installed/uninstalled applications from the client device, and at least one feature containing information about a user of the client device.

According to some embodiments, the method further includes generating, by the trainable ANN model, a similarity score amongst a plurality of features associated with the client device; determining, by the trainable ANN model, one or more new features from the plurality of features based on the similarity score. An embedding is generated based on the one or more new features; and adding, by the trainable ANN model, the one or more features to the plurality of features and the embedding to a plurality of embeddings associated with the plurality of features.

According to some embodiments, the embedding is generated externally based on one or more similarity scores and one or more heuristics associated with the plurality of features and injected to the trainable ANN model to add the one or more new features to the trainable ANN model.

According to some embodiments, the trainable ANN model is trained by remote server using pre-existing data at the remote server and a plurality of weak labels prior to being deployed at the client device.

Embodiments of the present invention disclose a system for performing a real-time predictive modeling at a client device. According to some embodiment, the system includes generating, by the Artificial Neural Network (ANN) model deployed at a client device, an inference performance associated with the trainable ANN model associated with an action performed at the client device based on data comprising a plurality of features associated with the client device. The inference performance is transmitted; receiving, by the trainable ANN model, a loss calculation generated based on the inference performance, indicating a requirement to correct the trainable ANN model, wherein the trainable ANN model generates one or more corrections for coefficients of the trainable ANN model based on the loss calculation; generating, by the trainable ANN model, one or more coefficients associated with the trainable ANN model and the data, by convoluting the data, and the trainable ANN model; and transmitting, by the trainable ANN model, one or more of the one or more corrections and the one or more coefficients indicating a successful predictive modeling of the trainable ANN model with the generation of the trainable ANN model.

The objects and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flow diagram, elaborating a process of creating a user-profile, according to some embodiments;

FIG. 2 is a flow diagram, elaborating a process elaborating a process of for performing a real-time predictive modeling of an Artificial Neural Network (ANN) model at a client device, according to some embodiments;

FIG. 3 shows a high-level block diagram of a system that includes a computing device according to some embodiments of the present invention;

FIG. 4 is a block diagram depicting modules within a ANN model, according to some embodiments of the present invention;

FIG. 5 is a diagram depicting a data collection at a remote server for training of an initial model to generate an ANN model, according to some embodiments of the present invention;

FIG. 6A is a diagram disclosing a high layer method for processing one or more coefficients is disclosed, according to some embodiments of the present invention;

FIG. 6B is a diagram disclosing a method for processing one or more coefficients by selecting one or more randomly sampled coefficients are generated is disclosed, according to some embodiments of the present invention; and

FIG. 6C is a diagram disclosing a method for processing the one or more coefficients is disclosed, according to some embodiments generated is disclosed, according to some embodiments of the present invention; and

FIG. 6D is a diagram disclosing a method for processing the one or more coefficients via a number of pretrained models is disclosed, according to some embodiments of the present invention;

FIG. 7 is a graphical illustration of a timeline and including a plurality of MOs according to some embodiments of the present invention; and

FIG. 8 depicting a flow diagram of a method for performing a real-time predictive modeling of an Artificial Neural Network (ANN) model at a client device, according to some embodiments.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing.” “computing.” “calculating.” “determining.” “establishing”. “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example. “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a system and a method for profiling a user of a computing device (e.g.: a smartphone, a laptop, etc.) according to the user's actions in the real world, receiving a list including at least one action from a remote server, executing at least one action of the list of action on the computing device, according to the user profile and according to at least one condition within the real world, generating an inference performance, transmitting one or more of one or more coefficients and one or more corrections to the remote server.

An embodiment may generate predictive models of mobile users' behavior, through real-time data collection and analysis. An embodiment may identify real-world user-moments in real time, through data gathering and analysis. An embodiment may create, and store information related to identified user-moments in a profile or in a timeline. For example, a moment object (MO) created by an embodiment may store or include a timestamp, moment-rules and rule-conditions as described herein and the MO may be included in, or associated with, a timeline.

An embodiment may generate a detailed timeline of a user by analyzing a user-moment, including active and passive engagement with his/her mobile device. An embodiment may create a user's timeline, in real-time, by identifying real-world moments the user experiences throughout the day. An embodiment may create, generate or define a user's timeline with MOs by analyzing data that's sent from, or received or generated by, the user's device.

An embodiment may use a timeline to predict the current, and future behavior of a user, even in cases in which the access to data is reduced. Output of some embodiments may be used by advertisers to target desired audiences based on their predicted behavior, thus increasing commercial conversion-rate levels significantly, and generating additional value to the end user.

Unlike known systems and methods, some embodiments of the invention may generate a consistently updating, detailed timeline for a user by analyzing the user's behavior in real-time. While known systems and methods might generate a timeline based on historical data, the timeline generated by known systems and methods is not consistently updated based on data that's collected and analyzed in real-time. In contrast, some embodiments may generate a timeline and consistently update or adjust it based on new data being sent from, or received by, a user's device. Additionally, some embodiments may predict what the user is about to do next, and the embodiments may further validate a prediction or assumption on the fly, in real-time. In some embodiments, the data collected may include a plurality of features.

An embodiment may associate a user with a specific group, specific set or specific audience of users. For example, based on a timeline, set of MOs or other information that associates (or matches) the user with a specific group, set or audience. An embodiment may associate a user with an audience or group independently. For example, based on real-time data and without relying on external data sources, an embodiment may adjust an association of a user based on real-time data, so media is not wasted on irrelevant traffic.

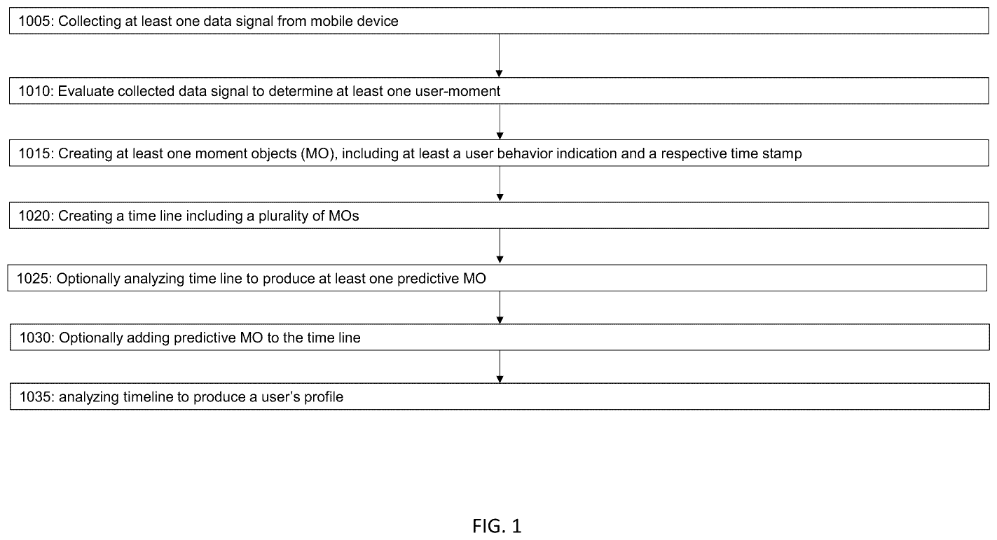

Reference is made to FIG. 1, showing a flow-diagram, elaborating a process of creating a user-profile, according to some embodiments, including the following steps:

According to some embodiments, the Software Development Kit (SDK) deployed in a mobile device may be configured to collect at least one data-signal from a mobile device, that may be indicative of a user-moment. (S1005). The at least on data-signal may correspond to data associated with a user and a computing device being used by the user. The collection of the data may be performed by an SDK installed in the computing device. The SDK may collect the data associated with the computing device as a feature vector. The feature vector may be a multi-dimensional features vector. The SDK may utilize a Machine Learning (ML) engine for collecting the data comprising a number of parameters. The SDK may collect the data locally based on permissions granted by one or more applications in the computing device.

Examples of the number of features may include, but are not limited to, a Wi-Fi connection status, demographic information, one or more device specifics, application usage data, a geolocation, and one or more installed/uninstalled applications from the computing device, and at least one feature containing information about a user of the computing device. The data may be collected by an SDK installed in the computing device.

A parameter like WIFI is crucial in determining an application to be presented to a user of the computing device. A direct relationship may exist between a size of the application, download interruptions, and a type of connection used by the user. The demographic information collected by the SDK may include user's age, gender, location, language preferences, and other demographic details. Examples of the device information collected by the SDK may include, but are not limited to, Information associated with the computing device including a device type, an operating system, a screen resolution, and a device Identification (ID). The application usage data may indicate interactions of the user with an application, including one or more features used by the user, a frequency of the application usage and a duration of each session. The geolocation data may be collected to understand moments of the user and preferences. Information associated with the one or more installed/uninstalled applications may allow advertisers to deliver more relevant and personalized advertisements. The advertisements may be tailored to match interests and preferences of the user, increasing a likelihood of engagement and conversion. Also, by analyzing the applications installed on the computing device, the advertisers may target specific user segments more effectively. The one or more installed/uninstalled applications may assist in identifying user with specific interests, behaviors, or needs, and serve advertisements that are more likely to resonate with the user. Tracking application uninstallation may provide insights into a user behavior and preferences. Understanding a type of applications the user chooses to remove may help advertisers identify patterns and preferences, allowing to refine targeting strategies.

In some embodiments, the SDK may apply at least one moment-rule on at least one data-signal, to identify and determine at least one user-moment (S1010). For example, the GPS location data-signal may be evaluated to determine that a user is currently commuting to work. According to some embodiments, an indication of the user-moment may be processed by the SDK. According to other embodiments, only the data-signal may be processed by the SDK. The SDK may perform the analysis of the collected data-signal, to determine at least one user-moment.

The at least one user-moment may include, for example: an indication of a user-action in the real world; an indication of a user-action on a computing device, a change in a condition of the computing device, and information regarding the context of such user-actions or changes in condition. Embodiments may identify, and determine at least one user-action.

According to some embodiments the SDK may generate a user-moment score, to determine the relevance and/or accuracy of at least one data-signal in identifying a specific user-moment.

The SDK may create at least one moment-object (MO), including at least a user-moment and a respective timestamp (S1015).

The SDK may create at least one timeline, including at least one MO (S1020).

In some embodiments, the SDK may be configured to analyze the timeline, to produce at least one predictive MO (S1025) including at least one predicted, future user-moment. For example, the SDK may collect all previous user-moments in the time line, and create a predictive MO, including a prediction. The SDK may further be configured to attribute a score to the predictive MO, stating a probability and relevance of the predicted user-moment.

According to some embodiments, the SDK may add at least one predictive MO to the timeline (S1030). The at least one predictive MO may be included in further analysis of the timeline by the SDK, to iteratively create subsequent predictive MOs.

The SDK may analyze the timeline to produce a user's profile, including data respective of their user-moments, and preferences (S1035). This user profile may later be utilized by an ANN model in the mobile device to target specific users for personalized advertisements and improving the advertisements conversion rate.

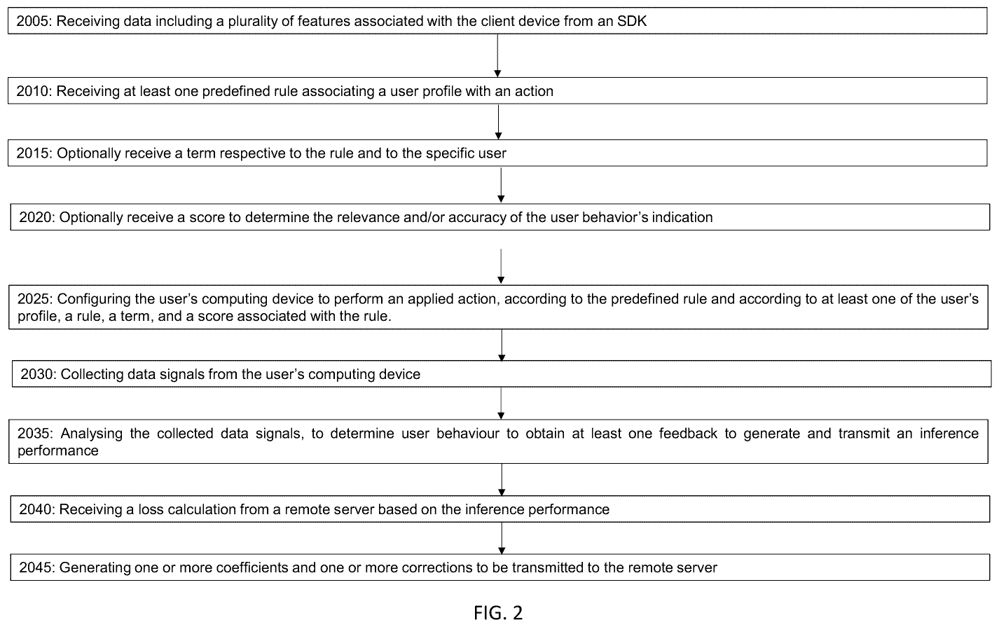

Reference is made to FIG. 2, showing a flow-diagram, elaborating a process of for performing a real-time predictive modeling of an Artificial Neural Network (ANN) model at a computing device, according to some embodiments, including the following steps:

The trainable ANN model may receive data including a number of features associated with the computing device from an SDK (S2005). The number of features may remain private and secure at the computing device so as to meet GDPR compliance, and it may also ensure that the trainable ANN model is not reverse engineered in an attempt to acquire private data associated with the trainable ANN model. As, even if the attempt to reverse engineer the trainable ANN model is made, the attempt may only be successful each of the number of features are accessed. The trainable ANN model and the SDK may be installed in the computing device. Examples of the number of features may include, but are not limited to, a Wi-Fi connection status, demographic information, one or more device specifics, application usage data, a geolocation, and one or more installed/uninstalled applications from the computing device, and at least one feature containing information about a user of the computing device. The data may be collected by an SDK installed in the computing device.

The trainable ANN model may process the data to generate an output. The output may be corresponding to performing an action at the computing device. In some embodiments, the action may include displaying one or more advertisements on the computing device. In some embodiments, the action may include displaying one or more offers on the computing device to a user handling the computing device. The one or more advertisements and the one or more offers may be determined based on the number of features collected by the SDK. The one or more advertisements and the one or more model based offers is selected amongst a plurality of advertisements and a plurality of model-based offers stored in the computing device along with the trainable ANN model.

For example, the action may include presenting one of the one or more advertisements and the one or more model based offers at the computing device associated with a specific user-moment. The one or more advertisements or the one or more model based offers may be presented in a form of an icon of a mobile app. Pertaining to the example of commuting-to-work, the trainable ANN model may present an icon, that serves as a link to advertise a mobile app, that is directed to assisting users in selecting commuter bus lines.

The trainable ANN model may receive at least one predefined applied-rule associating the user profile with an action (S2010).

According to some embodiments, the trainable ANN model may receive a rule-condition respective to the at least one applied-rule and to the user profile (S2015). The rule-condition may apply restrictions or enhancements on the applied-rule, according to circumstances.

According to some embodiments, the trainable ANN model may receive a score, to determine the relevance and/or accuracy of at least one predictive MO (S2020).

The trainable ANN model may configure the computing device (e.g.: mobile phone) to perform an action according to at least one of: the user's profile, an applied-rule, and a rule-condition and a score associated with the applied-rule (S2025). According to some embodiments, the action may be configured and executed on the user's computing-device (e.g. mobile device) by the SDK or an Action SDK (ASDK) installed therein, as elaborated further below.

According to some embodiments, the trainable ANN model may be configured to generate an inference performance associated with the action performed at the computing device. The inference performance may be based on the data comprising the number of features associated with the computing device. The inference performance is to be transmitted to the remote server. For, generating the inference performance, the trainable ANN model may also collect at least one data-signal from the user's mobile device, pertaining to the user's behavior following the execution of the action (S2030). For example, if the action included presenting an icon on the device screen that links to an installation of an application on an “app-store”, the trainable ANN model may collect data-signals from the mobile device to determine whether the user has clicked the icon, browsed through a relevant website, installed the respective app, etc.

According to some embodiments, the trainable ANN model may analyze the at least one data-signal, to obtain at least one feedback from the user following the execution of the action (S2035). Further, the inference performance may be generated and sent to the remote server.

According to some embodiments, the collecting of the at least one data-signal from the user's mobile device, analysis of the at least one data-signal, obtaining the feedback and sending the feedback to the remote server may be performed by the trainable ANN model, as elaborated below.

In response to receiving the interference performance, the remote server may be configured to generate a loss calculation associated with the inference performance and the computing device. The loss calculation may correspond to indicating a requirement to correct the trainable ANN model. The remote server may transmit the loss calculation to the computing device and the loss calculation may be forwarded to the trainable ANN model.

The trainable ANN model may receive the loss calculation from the remote server (S2040). The trainable ANN model, in response to receiving the loss calculation, may be configured to generate one or more corrections for coefficients of the trainable ANN model based on the loss calculation (S2045). The one or more corrections may be performed at the trainable ANN model. According to some embodiments, the computing device, specifically, the trainable ANN model may generate the loss calculation.

The trainable ANN model may generate one or more coefficients and the one or more coefficients may be related to trainable ANN model and the data. The trainable ANN model may convolute the data, and the trainable ANN model to generate the one or more coefficients.

The trainable ANN model may then transmit one or more of the one or more corrections and the one or more coefficients generated by convoluting the data and the trainable ANN model indicating a successful predictive modeling of the trainable ANN model with the generation of the trainable ANN model to the remote server. According to some embodiments, prior to transmitting the one or more coefficients the trainable ANN model may select a first coefficient amongst the one or more coefficients associated with a higher layer of the trainable ANN model. The higher layer corresponds to an output based on the data. The trainable ANN model may generate an encryption layer of a plurality of pseudo random numbers based on the first coefficient. The trainable ANN model may add a noise to the encryption layer and the first coefficient and transmit the first coefficient to the remote server.

According to some embodiments, prior to transmitting the one or more corrections, the trainable ANN model may generate at least one correction amongst the one or more corrections incorporated to a previous coefficient of the trainable ANN model and transmit the at least one correction. The at least one correction may correspond to a masked image of an activating pattern associated with the trainable ANN model. According to some embodiments, prior to transmitting the one or more coefficients, the trainable ANN model may divide the trainable ANN model into a personal data model and a public data model. The division may be based on personal features and open source features amongst the data. Furthermore, the trainable ANN model may transmit at least one coefficient associated with the public data model associated with the open source features to the remote server.

The remote server may also update a global model based on the one or more coefficients and the one or more corrections received from the computing device. The remote server upon receiving the one or more coefficients, may aggregate one or more weight updates with respect to the trainable ANN model. Upon aggregating, the remote server may generate the updated global model with a time stamp and a version tag based on the one or more weight updates. A number of features and tokens may be added using embedding seeded on a latest available up-to-date model.

$$\text{?} = \text{?} \frac{\text{?}}{\text{?}} \text{?} \qquad equation ( 1 )$$

$$\text{?} \text{indicates text missing or illegible when filed}$$

where:
is the upd roundt+1.
are the updated model vice/at round t+1.

ng is the number of tra ar es on device A. r& ist. number of training examples across all devices.

The above disclosed ensemble of models and their relations may be used for transmitting the one or more coefficients. The one or more coefficients may be communicated back to the remote server in a GDPR compliance manner as private data is held back at the computing device, and only conclusions of the model which is by design not interpretable to anything besides the trainable ANN model are transmitted to the remote server. By decentralizing the data and a machine learning processing, the present invention offers a robust and privacy-compliant solution for the advertising and other targeting based applications, enhancing both user trust and advertising effectiveness. As more applications implement the SDK and interact with the same user, an amount of information learned about the user increases, resulting in a more reliable and accurate user profile thus better offers.

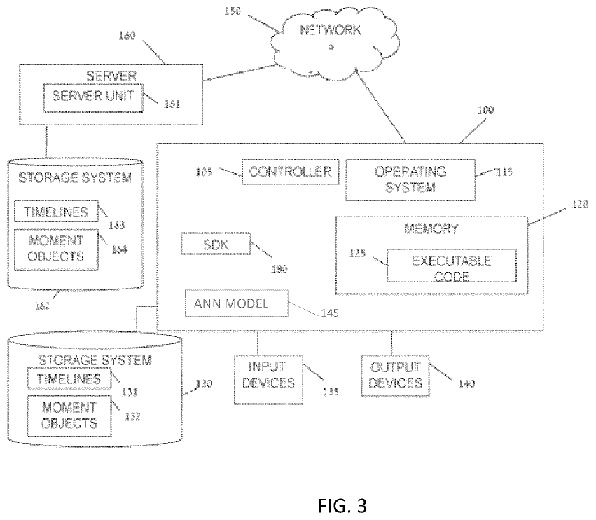

Reference is made to FIG. 3, showing a high-level block diagram of a system that includes computing device 100 according to some embodiments of the present invention. As shown, a system may include a remote server 160 that may include a server unit 161 and a system may include a network 150. Computing device 100 may be a user's device, for example, computing device 100 may be, or may be included in, a smartphone, a mobile device or mobile communication device, a tablet, a laptop or any other suitable user device.

Computing device 100 may include a controller 105 that may be, for example, a central processing unit processor (CPU), a chip or any suitable computing or computational device, an operating system 115, a memory 120, executable code 125, a storage system 130, input devices 135 and output devices 140. Controller 105 (or one or more controllers or processors, possibly across multiple units or devices) may be configured (e.g., by executing software or code) to carry out methods described herein, and/or to execute or act as the various modules, units, etc. More than one computing device 100 may be included in, and one or more computing devices 100 may be, or act as the components of, a system according to some embodiments of the invention.

More than one computing device 100 may be included, and one or more computing devices 100 may act as the various components. For example, although a single computing device 100 is shown in FIG. 1, a system according to some embodiments may include hundreds of thousands computing devices 100, e.g., server 160 may communicate with a very large number of smartphones.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system, e.g., Android or iOS.

Memory 120 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be any executable code, e.g., an application (app), a program, a process, task or script. Executable code 125 may be executed by controller 105 possibly under control of operating system 115. For example, executable code 125 may be an application that defines, creates or generates Moment Objects (MOs) and/or timelines as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein. e.g., a data collection unit, a data storage unit, a data analysis unit and a timeline generation unit may be, or may include, controller 105, memory 120 and executable code 125.

Storage system 130 may be or may include, for example, flash memory, an external or internal hard disk drive, a CD-Recordable (CD-R) drive, a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile and/or flash memory having the storage capacity of storage system 130. Accordingly, although shown as a separate component, storage system 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, (I/O) devices 135 and 140 may include a wireless network interface component (e.g., a WiFi system or component), a Bluetooth component and the like.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, cellular or smart phone, a personal computer, a laptop computer, a server computer, a network device, or any other suitable computing device.

Network 150 may be, may comprise or may be part of a private or public IP network, or the internet, or a combination thereof. Additionally. or alternatively, network 150 may be, comprise or be part of a global system for mobile communications (GSM) network. For example, network 150 may include or comprise an IP network such as the internet, a GSM related network and any equipment for bridging or otherwise connecting such networks as known in the art. In addition, network 150 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 150 are implied but not shown, e.g., access points, base stations, communication satellites, GPS satellites, routers, telephone switches, etc. It will be recognized that embodiments of the invention are not limited by the nature of network 150.

Software development kit (SDK) 180 may be, or may be included in, executable code 125. For example, SDK 180 may be a software application (app), executed by controller 105, and designed to create timelines and MOs as described herein. Server unit 161 may be, or may be included in, executable code 125 in server 160. For example, server unit 161 may be a software application, executed by controller 105 in server 160, and designed to communicate with a plurality of computing device 100 and create timelines and MOs as described herein.

As shown, storage system 130 may include timelines 131 and Mos 132. As shown, storage 162 may include timelines 163 and Mos 164. For example, SDK 180 may generate, update and/or receive timelines 131 and Mos 132 and an ANN model 145 deployed in the computing device 100 may generate, update and/or receive timelines 163 and Mos 164 as further described herein.

In some embodiments, generating and using predictive profiles, timelines and MOs may be accomplished using several units or layers, for example, an embodiment may include a data collection unit or layer, a data storage unit or layer, a data analysis unit or layer and a serving unit or layer.

In some embodiments, data collection may be performed by SDKs 180 installed in a user's computing-devices (e.g.: millions of mobile devices). The SDK 180 may be either integrated into applications (e.g.: hybrid mobile apps, native mobile apps) or installed within the computing-device 100 as separate software modules. In some embodiments, SDK 180 may include a data library module that collects signals from device 100. Determining a user-moment (e.g.: a user-action and/or a condition of the user's device) may be based on a plurality of data-signals. For example, based on input from a global positioning system (GPS) included in device 100, the SDK 180 may determine whether a user is walking or driving. In another example, according to input from the device's operating system (OS, 115), the SDK 180 may determine what application a user is currently using.

In some embodiments, a data analysis unit may analyze collected data, e.g., an analysis result may be, or may be used to determine a definitive conclusion, for example: a user's behavior may be determined based on analysis of collected data, e.g., whether or not a user is idle, walking, running, driving or riding a bicycle. An indication of the user's behavior may be sent (e.g., by SDK 180) to an ANN model 145 in the computing-device 100.

In some embodiments, data collected by SDK 180 may be analyzed, by SDK 180, immediately or in in real time, e.g., to identify and create MOs and/or to update a profile. Further, the SDK 180 may create a user profile for the user of the computing device 100 based on the data. The SDK 180 may deploy the trainable ANN model 145 in the computing device 100 upon generation of the user profile.

In some embodiments, sending data to ANN model 145 may be event or trigger based. e.g. following identification of a user-moment by SDK 180, or at a predefined period. For example, data may be sent following a change in the computing device's condition (e.g.: when device 100 is connected or disconnected from WIFI, the state logged and is sent, by SDK 180, to ANN model 145). In another example, data associated with at least one user-moment may be sent by SDK 180 to the trainable ANN model 145, triggered by the identification of at least one predefined, identified user-moment event associated with at least one user-action (e.g.: when the user is identified as riding a bicycle). In some embodiments, configurations or cases, collected data may be sent to ANN model 145 regularly, in a raw state, in pre-defined intervals. For example, information related to nearby WIFI networks, may be sent as raw data to ANN model 145 at a per-set interval. Raw data sent to ANN model 145 may be analyzed, by ANN model 145, in real-time once received.

In some embodiments, SDK 180 may be integrated into a host application, and may thus gain access to the data permissions the application received from the user. In some embodiments. SDK 180 may “ride” the host application's permissions to gain access to user data.

Timelines. MOs and collected data may be stored in the computing device 100. Although a single remote server 160 is shown in FIG. 1, any number of remote servers 160 may collaborate in receiving and processing information from the computing device 100 as described.

A user profile may include or may be updated according to, a timeline and one or more MOs. Accordingly, a user profile may include indications of user-actions, timing of user-actions, and indications or information related to what a user is expected to do, need or want (e.g.: predicted user-moments).

A profile, timeline and set of MOs of a user may be associated or linked to a computing device. For example, the SDKs 180 and the remote server 160 may store data (e.g., raw data, profile, timeline and set of MOs) in association with a device identification code or number (ID). e.g., a profile, timeline and set of MOs of a user may be associated with an Advertising Identifier (IDFA) that is a unique ID for iOS devices.

In some embodiments, each user-profile may include a current-MO, reflecting the state of a respective user in the real world, as well as historic data that was used to form the current-MO. According to some embodiments, ANN model 145 may be configured to change the current-MO upon reception of at least one additional data-signal sent by SDK 180. According to some embodiments, ANN model 145 may be configured to process the at least one additional data-signal along with previous data to identify a user-moment and determine an associated moment-rule.

For example, in some embodiments, each profile may be associated with a snapshot, describing the user (reflective state) and this snapshot may be updated according to incoming data and reached conclusions. In addition, each profile may include a complete history of raw data and conclusions reached through analysis, that when analyzed, with or without additional data, might change the reflective state. Specifically, the trainable ANN model 145 may generate a prediction score and a snapshot of the number of features in the data used to generate an output. The output includes the one or more advertisements, the one or more model based offers displayed at the computing device. Furthermore, the trainable ANN model 145 may compress the prediction score and the snapshot. The prediction score and the snapshot is stored at the computing device.

According to some embodiments, the trainable ANN model 145 may be configured to change at least one existing MO upon reception of at least one additional incoming data-signal. According to additional embodiments, the trainable ANN model 145 may be configured to store the at least one additional data-signal, and analyze the data-signal together with other, previously received data-signals, or with data-signals that may be expected to be received later.

Every moment-rule and rule-condition may be considered according to other rule-conditions in a user-profile. For example, the trainable ANN model 145 may be configured to identify a specific user-moment, and select a specific moment-rule based on at least one incoming data-signal, or await the reception of additional data-signals before reaching a conclusion, according to at least one score. In another example, a moment-rule may be selected from a plurality of moment-rules by comparing the strength of the rule-conditions that make each moment-rule, in order to choose the most definitive conclusion.

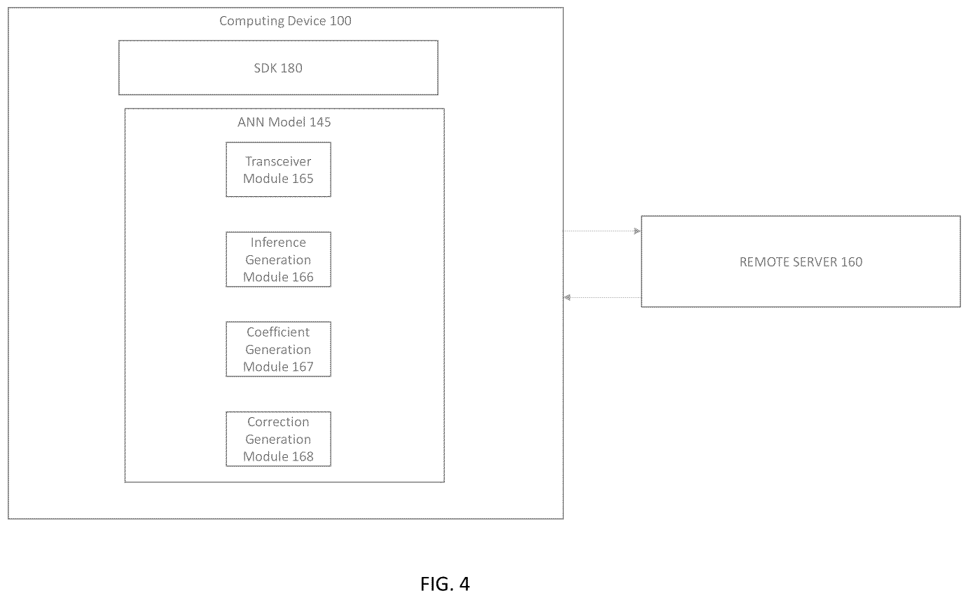

Reference is made to FIG. 4, which is a block diagram, depicting modules within a ANN model 145, according to some embodiments of the present invention. The trainable ANN model 145 may be deployed in a computing device and may be configured to process data associated with the computing device using one or more Machine Learning techniques at the computing device. As elaborated above, ANN model 145 may be configured to: receive data comprising a number of features associated with the computing device; process the data to generate an output corresponding to performing an action at the computing device; generate an inference performance associated with an action performed at the computing device based on the data, transmit the inference performance to a remote server; receive a loss calculation generated based on the inference performance associated with the trainable ANN model 145, indicating a requirement to correct the trainable ANN model 145, the trainable ANN model 145 generates one or more corrections for coefficients of the trainable ANN model 145 based on the loss calculation; generate one or more coefficients associated with the trainable ANN model 145 and the data, by convoluting the data, and the trainable ANN model 145; transmit one of the one or more corrections and the one or more coefficients generated by convoluting the data and the trainable ANN model 145 indicating a successful predictive modeling of the trainable ANN model 145 with the generation of the trainable ANN model 145.

As depicted in embodiment of FIG. 4, the trainable ANN model 145 may include at least one of: a transceiver module 165, an inference generation module 166, a coefficient generation module 167, and a correction generation module 168.

According to some embodiments, the receiving module may be configured to receive the data including the number of features from the SDK. The SDK may collect the data associated with the computing device as a feature vector. The feature vector may be a multi-dimensional features vector. Upon a successful reception of the number of features, the data may be forwarded to the inference generation module 166. The inference generation module 166 may be configured to generate an inference performance. The inference performance may be related to an action performed at the computing device based on the number of features. The inference performance may be transmitted to a remote server by the transceiver module 165 and the remote server may generate a loss calculation related to the trainable ANN model 145. The remote server may transmit the loss calculation to the trainable ANN model 145 and the transceiver module 165 may receive the loss calculation. In some embodiments, the loss calculation may be generated by the inference generation module 166. The loss calculation may indicate a requirement to correct the trainable ANN model 145. Based on the loss calculation, the inference generation model generates one or more corrections for coefficients of the trainable ANN model 145.

The coefficient generation module 167 may generate one or more coefficients associated with the trainable ANN model 145 and the data. The one or more coefficients may be generated by convoluting the data, and the trainable ANN model.

The transceiver module 165 may transmit one or more of the one or more corrections and the one or more coefficients indicating a successful predictive modeling of the trainable ANN model 145 with the generation of the trainable ANN model 145 to the remote server.

In some embodiments, for the transmission of the one or more coefficients, the coefficient generation module 167 may select a first coefficient amongst the one or more coefficients associated with a higher layer of the trainable ANN model 145. The higher layer corresponds to an output based on the data. The output may include one or more advertisements, one or more model based offers and the action to be performed is displaying one of the one or more advertisements and the one or more model based offers at the computing device.

Further, the coefficient generation module 167 may generate an encryption layer of a plurality of pseudo random numbers based on the first coefficient and add a noise to the encryption layer and the first coefficient. Further, the first coefficient may be transmitted to the remote server.

In some embodiments, the inference generation module 166 may generate at least one correction amongst the one or more corrections incorporated to a previous coefficient of the trainable ANN model 145. The transceiver module 165 may transmit the at least one correction. The at least one correction may correspond to a masked image of an activating pattern associated with the trainable ANN model 145.

In some embodiments, the coefficient generation module 167 may divide the trainable ANN model 145 based on personal features and open source features amongst the data, into a personal data model and a public data model. The transceiver module 165 may transmit at least one coefficient associated with the public data model associated with the open source features to the remote server.

According to some embodiments of the present invention, one or more new tokens and features may be added without a need to update the deployed model in the client without a need of direct labeling. A similarity score amongst a number of features associated with the computing device may be generated by the Inference generation module 166. The inference generation module 166 may determine one or more new features from the number of features based on the similarity score. An embedding may be generated based on the one or more new features. The Inference generation module 166 may then add the one or more features to the number of features and the embedding to a plurality of embeddings associated with the number of features. The embeddings generated may be non-reversible and may not allow for a reconstruction of personal data especially when model parameters are not held by another user, adhering to GDPR guidelines. The embedding may be updated and utilized without compromising user privacy. According to some embodiments, the embeddings may be adjusted based on ongoing interactions between the number of features and may produce a vectoric interpretation (feature embedding) of each feature. Examples of feature embedding: glove (word2vec, GPT exc).

According to some embodiments, the computing device may download a light quantized and distilled LLM (an open GPT2 model) and that may be addressed via a prompt. The prompt may include a list of potential offers with a description (in language or other interceptable formats). The prompt may include features descriptive of the user (device, used apps, location, etc.) as explained above, and more, the features may be aligned to be interpretable as well to the LLM. The LLM may be provided a prompt containing the features and the one or more offers and provide a recommendation in descending order according to model inference desired guidelines (if applicable). The LLM may be internally fine-tuned according to the user's performance.

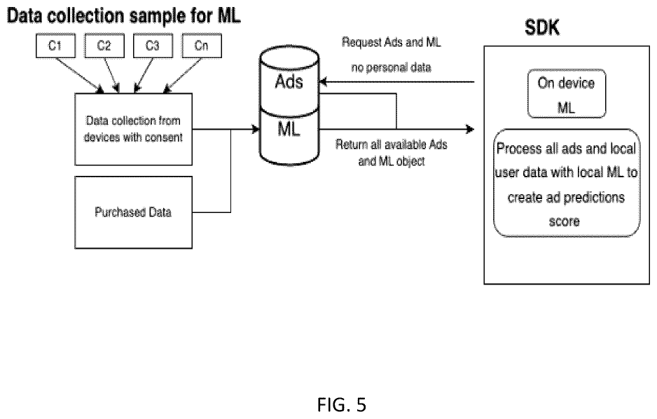

Reference is made to FIG. 5, in which a data collection at a remote server is disclosed for training of an initial model to generate an ANN model, according to some embodiments of the present invention. The trainable ANN model may be a fully connected artificial multi-layered neural network (ANN) with sigmoid activations. The training of the initial model may be performed at a remote server. A number of users may be incentivized to participate in the data collection for the training of the initial model. The SDK may incorporate mechanisms to compensate the number of users for a participation in the data collection and the model training. The data collection of information, also referred as allowed data, may be gathered and used for training the initial model, later to be tagged and deployed on the client side.

In the training the initial model is trained using appropriate framework (tensorflow/pytorch) and appropriate optimization (adam gd) in an appropriate training strategy agreeable convergence. After convergence, the model is tagged, saved and sealed, its coefficients are extracted and used to initialize the client (front end) model. Several such models may run in parallel and each suitable for a group of similar banner categories and may provide a conversion prediction for the corresponding group.

To train the initial model, a small sample of data may be obtained from a number of sources. The number of sources may include applications designed specifically to obtain users' consent for data collection, a compensation model for the user for providing the data, with a full GDPR compliant agreement, communicated by advertisers/publishers accompanied by a ULAA to the user, and purchased data from multiple sources.

In some embodiments, one or more weak labels like engagement signals may also be used to train the initial model, enhancing training robustness. The one or more weak labels may be used when the data to train the initial data is scarcely available, and instead of directly training the initial model, an available proxy signal may be used that may also assist in a pattern detection during the training of the initial modeling. Examples of the weak labels may include, but are not limited to, engagement with advertisement/offer-clicks, durations, eye movement, touch interaction, masking a feature and predicting the feature using the other features, generation of labels using another heuristic, and a label design with an emphasis on inhibiting the detection of personal GDPR-protected data. The trainable ANN model may be deployed at a computing device and may process.

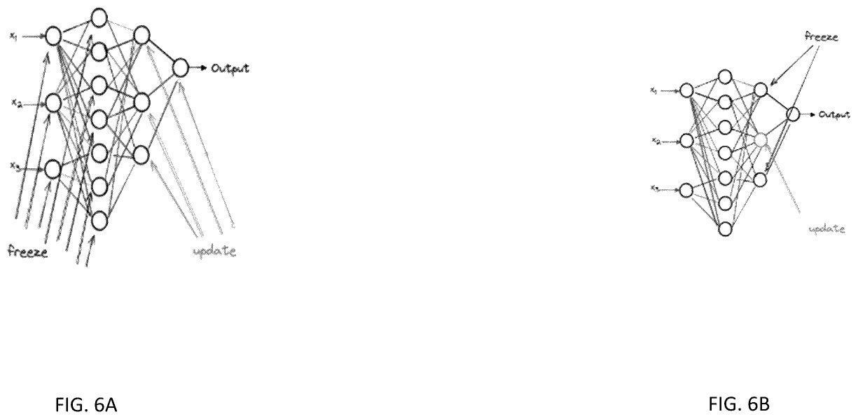

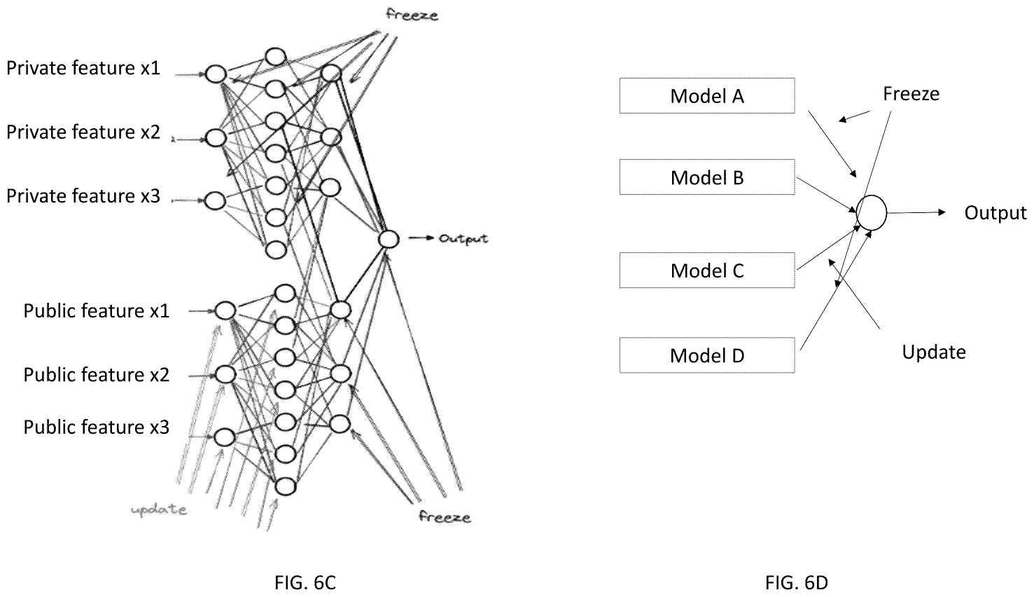

Reference is made to FIG. 6A, in which a high layer method for processing one or more coefficients is disclosed, according to some embodiments of the present invention. The method may include using a high order ANN layer. The high order ANN layer may keep input values uninterpretable. The method may include selecting a first coefficient amongst the one or more coefficients associated with a higher layer of a ANN model. The higher layer may correspond to an output based on data comprising a number of features associated with a computing device. The method may further include generating an encryption layer of a plurality of pseudo random numbers based on the first coefficient, and adding a noise to the encryption layer and the first coefficient. Further, the first coefficient may be transmitted to a remote server such that the data of the computing device is secure at the computing device and the transmission is in a compliance with GDPR.

Reference is made to FIG. 6B, in which method for processing one or more coefficients by selecting one or more randomly sampled coefficients are generated is disclosed, according to some embodiments of the present invention. The method may include generating at least one correction amongst the one or more corrections incorporated to a previous coefficient of the trainable ANN model. Further, the at least one correction may be transmitted to the remote server. The at least one correction may correspond to a masked image of an activating pattern associated with the trainable ANN model.

Reference is made to FIG. 6C, in which a method for processing the one or more coefficients is disclosed, according to some embodiments. The method may include dividing the trainable ANN model based on personal features and open source features amongst the data, into a personal data model and a public data model. Further, the at least one coefficient associated with the public data model associated with the open source features to the remote server.

According to some embodiments, an ensemble of pretrained models may be used. Reference is made to FIG. 6D, in which a method for processing the one or more coefficients via a number of pretrained models is disclosed.

The ensemble of pretrained models may be weighted and a selection of models is trained and versioned offline (using allowed data). Further, the ensemble of trained models may be used to predict on the computing device. The ensemble of trained models' performance on the computing device may influence a model selection weight and may correct a configuration and parameters used from inference performance associated with the ensemble of the trained models, or send corrections (coefficient gradients calculated from a loss calculation received from the remote server). The method may be achieved by implementing Multi-armed bandits/RL/Retraining of a regression model (online learning). Personal data of a user may be masked and only the model's scores may be sent back making it impossible to trace back data associated with the user without exact implementations of the ensemble of trained models.

The ensemble of trained models may be a federated multi model and each model may initially be trained differently. Each model may be bootstrapped with different weight initializations or different data sample. Each model may be weighted according to a performance of each model. Each model's performance may correspond to multi-armed bandits, linear regression, prediction of coefficients, and uncertainty estimation.

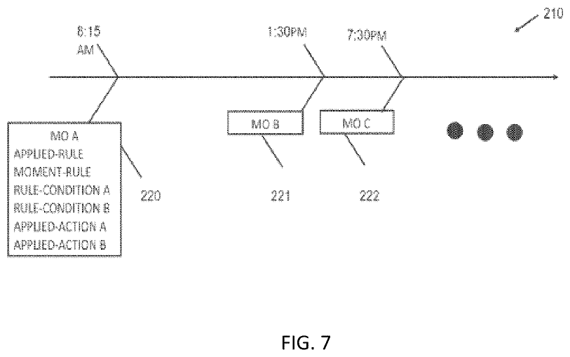

Reference is made to FIG. 7, which is a graphical illustration of a timeline and MOs according to some embodiments of the present invention. In some embodiments, MOs may relate the user's behavior in relation to the real-world user-actions, and to the real-world context (e.g.: timing, concurrent real-world events, concurrent events on the user's mobile device, etc.) of that behavior. In some embodiments, user behavior may relate to current user-actions and/or to predicted actions of a user.

As shown by MO 220, an MO may include at least one of: a moment-rule, an applied-rule, a rule-condition (e.g., rule-condition A and rule-condition B) and a applied-action (e.g.: invoke application A and application B). It is noted that any number of rules, rule-conditions and applied-actions may be included in, pointed or referenced by, or associated with, an MO. In some embodiments, each moment-rule may be met when or if one or more of the rule's rule-conditions apply or match an input. Rules in an MO may be the starting point for an algorithm or logic that may reach conclusions about the user's behavior and/or moments on the timeline.

A rule-condition may include data of various types and formats. For example, a rule-condition may include, or be a combination of data types such as raw data, processed data, device state data, enriched data, historical data, and historical conclusions. A set of rule-conditions that match an input data-signal may define which moment-rule is met, executed or applied.

In some embodiments, at least one moment-rule in an MO may be attributed a score for determining the strength of the conclusion, based on the data they rely on. For example, there may be strong rule-condition and weak rule-conditions, depending on the data quality and volume present, used to fill the rule-condition.

For example, an MO may include several moment-rules where each may be a combination of new, prior, or current data, circumstances or past conclusions. Each variable in an MO or profile may be assigned with a score, and the entire index of a moment-rule may be a combination of these scores. Rules may have their own score based on the winning rule-condition and data-signal score, used to meet the rule, combined with a predefined index. According to some embodiments, moment-rules may be compared among each other in order to generate conclusion and identify a user-moment with the highest probability.

Generally, a data-signal may be associated with a score as described above, rule-condition moment-rules and applied-rules may also be associated with a score that relates to a plurality of data-signal scores, and/or pre-set factors. The trainable ANN model may be configured to combine the data-signals, and accumulate the scores associated with the two data-signals (e.g. sum the scores with respective pre-set factors), to evaluate the collected data, and ascertain a high probability that the user is performing a specific task. The trainable ANN model may further be configured to perform an applied action according to the determined user-moment, based on at least one applied-rule.

In some embodiments, when a rule-condition is fulfilled, a moment-rule may be applied, and an MO may be generated and logged for the user. For example, the MO may be stored as part of the user's user-profile.

In some embodiments. MOs may be defined within a specific scope. For example, MOs may have a predefined expiration time, and may also expire prior to that based on other MOs logged for the user or based on incoming data. As shown, Mos 220, 221 and 222 may be associated or linked with a timeline 210. For example, an MO may include a timestamp thus linking or associated the MO with a timeline. For the sake of clarity, data included in an MO is only shown for MO A 220. It will be understood that other methods of storing data related to moments as described herein may be used and that MOs as described herein are a simplified example, thus, it is recognized that the scope of the invention is not limited by the method or way data related to moments is stored and/or associated with a timeline.

Some of MOs 220, 221 and 222 may be generated as described and may reflect real-time aspects and some of MOs 220, 221 and 222 may be predictive.

In some embodiments, predicted MOs for a user may be automatically generated (e.g., by server 160 and/or by SDK 180) based on historical moments (or MOs) logged for the user.

According to some embodiments, the trainable ANN model may use predictive MOs to suggest relevant applications to a user, prior to the time the user might need them (right when he's about to use or need to use the applications).

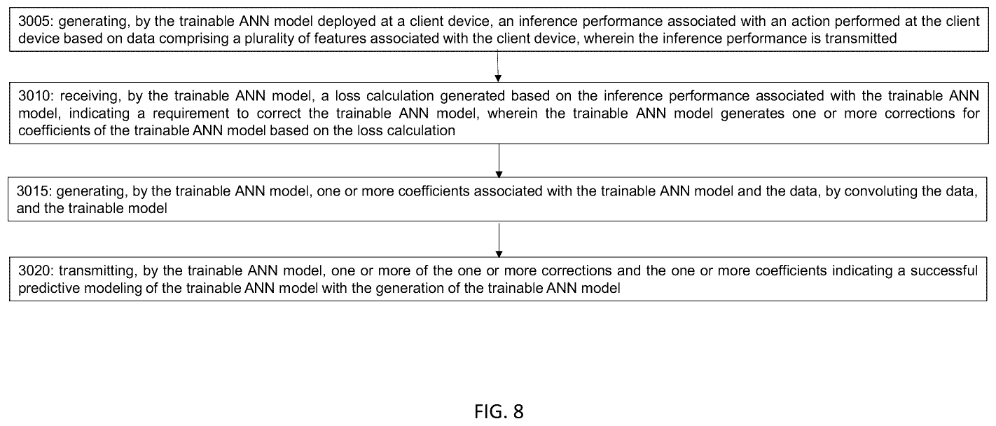

Reference is made to FIG. 8, depicting a flow diagram of a method for performing a real-time predictive modeling of an Artificial Neural Network (ANN) model at a client device, according to some embodiments. The method includes the steps of:
generating, by the trainable ANN model deployed at a client device, an inference performance associated with an action performed at the client device based on data comprising a plurality of features associated with the client device, wherein the inference performance is transmitted (S3005);
receiving, by the trainable ANN model, a loss calculation generated based on the inference performance associated with the trainable ANN model, indicating a requirement to correct the trainable ANN model, wherein the trainable ANN model generates one or more corrections for coefficients of the trainable ANN model based on the loss calculation (S3010);
generating, by the trainable ANN model, one or more coefficients associated with the trainable ANN model and the data, by convoluting the data, and the trainable ANN model (3015);
transmitting, by the trainable ANN model, one of the one or more corrections and the one or more coefficients indicating a successful predictive modelling of the trainable ANN model with the generation of the trainable ANN model (3020);

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for performing a real-time predictive modeling of a trainable Artificial Neural Network (ANN) model at a client device, the method comprising:
generating, by the trainable ANN model deployed at a client device, an inference performance associated with an action performed at the client device based on data comprising a plurality of features associated with the client device, wherein the inference performance is transmitted;
receiving, by the trainable ANN model, a loss calculation generated based on the inference performance associated with the trainable ANN model, indicating a requirement to correct the trainable ANN model, wherein the trainable ANN model generates one or more corrections for coefficients of the trainable ANN model based on the loss calculation;
generating, by the trainable ANN model, one or more coefficients associated with the trainable ANN model and the data, by convoluting the data, and the trainable model; and
transmitting, by the trainable ANN model, one or more of the one or more corrections and the one or more coefficients indicating a successful predictive modeling of the trainable ANN model with the generation of the trainable ANN model.

2. The method according to claim 1, wherein the inference performance and one or more of the one or more corrections and the one or more coefficients is transmitted to a remote server.

3. The method according to claim 2, wherein the remote server generates the loss calculation based on the inference performance and updates a global model based on the one or more coefficients and the one or more corrections.

4. The method according to claim 1, wherein a remote server generates the loss calculation based on the inference performance and updates a global model based on the one or more coefficients and the one or more corrections.

5. The method according to claim 1, wherein the client device generates the loss calculation based on the inference performance.

6. The method according to claim 1, further comprising:
collecting, by a Software Development Kit (SDK), data associated with the client device as a feature vector from the client device;
creating, by the SDK, a user profile for the user based on the data;
deploying, by the SDK, the trainable ANN model at the client device,
wherein the trainable ANN model is generated based on global data at a remote server; and
processing, by the trainable ANN model, the data comprising a plurality of features associated with the client device to generate an output corresponding to performing an action at the client device.

7. The method according to claim 1, wherein transmitting the one or more coefficients comprises:
selecting a first coefficient amongst the one or more coefficients associated with a higher layer of the trainable ANN model, wherein the higher layer corresponds to an output based on the data;
generating an encryption layer of a plurality of pseudo random numbers based on the first coefficient;
adding a noise to the encryption layer and the first coefficient; and
transmitting the first coefficient to a remote server.

8. The method according to claim 1, wherein transmitting the one or more corrections comprises:
generating at least one correction amongst the one or more corrections incorporated to a previous coefficient of the trainable ANN model; and
transmitting the at least one correction, wherein the at least one correction corresponds to a masked image of an activating pattern associated with the trainable ANN model.

9. The method according to claim 1, wherein transmitting the one or more coefficients comprises:
dividing the trainable ANN model based on personal features and open source features amongst the data, into a personal data model and a public data model; and
transmitting at least one coefficient associated with the public data model associated with the open source features to the remote server.

10. The method according to claim 1, further comprising:
receiving, by a remote server, the one or more coefficients from the client device;
aggregating, by the remote server, one or more weight updates with respect to the trainable ANN model; and
generating, by the remote server, an updated global model with a time stamp and a version tag based on the one or more weight updates.

11. The method according to claim 6, wherein the output comprises one or more advertisements, one or more model based offers and the action to be performed is displaying one of the one or more advertisements and the one or more model based offers at the client device.

12. The method according to claim 11, wherein the one or more advertisements and the one or more model based offers is selected amongst a plurality of advertisements and a plurality of model-based offers stored in a client device along with a trainable ANN model.

13. The method according to claim 1, wherein one or more advertisements and one or more model based offers is selected amongst a plurality of advertisements and a plurality of model-based offers stored in the client device along with the trainable ANN model.

14. The method according to claim 1 further comprising:
generating, by the trainable ANN model, a prediction score and a snapshot of the plurality of features in the data used to generate the output; and
compressing, by the trainable ANN model, the prediction score and the snapshot, wherein the prediction score and the snapshot is stored at the client device.

15. The method according to claim 1, wherein the inference performance is generated based on a response received from a user to the action performed at the client device.

16. The method according to claim 1, wherein the plurality of features comprises a Wi-Fi connection status, demographic information, one or more device specifics, application usage data, a geolocation, and or more installed/uninstalled applications from the client device, and at least one feature containing information about a user of the client device.

17. The method according to claim 1, further comprising:
generating, by the trainable ANN model, a similarity score amongst a plurality of features associated with the client device;
determining, by the trainable ANN model, one or more new features from the plurality of features based on the similarity score, wherein an embedding is generated based on the one or more new features;
adding, by the trainable ANN model, the one or more features to the plurality of features and the embedding to a plurality of embeddings associated with the plurality of features.

18. The according to claim 17, wherein the embedding is generated externally based on one or more similarity scores and one or more heuristics associated with the plurality of features and injected to the trainable ANN model to add the one or more new features to the trainable ANN model.

19. The method according to claim 1, wherein the trainable ANN model is trained by remote server using pre-existing data at the remote server and a plurality of weak labels prior to being deployed at the client device.

20. A system for performing a real-time predictive modeling at a client device, the method comprising:
generating, by an Artificial Neural Network (ANN) model deployed at the client device, an inference performance associated with the trainable ANN model associated with an action performed at the client device based on data comprising a plurality of features associated with the client device, wherein the inference performance is transmitted;
receiving, by the trainable ANN model, a loss calculation generated based on the inference performance, indicating a requirement to correct the trainable ANN model, wherein the trainable ANN model generates one or more corrections for coefficients of the trainable ANN model based on the loss calculation; trainable;
generating, by the trainable ANN model, one or more coefficients associated with the trainable ANN model and the data, by convoluting the data, and the trainable model;
transmitting, by the trainable ANN model, one or more of the one or more corrections and the one or more coefficients indicating a successful predictive modeling of the trainable ANN model with the generation of the trainable ANN model.
